(19) United States
(12) Patent Application Publication
(10) Pub. No.: US 2013/0278512 A1
(43) Pub. Date: Oct. 24, 2013

(54) TOUCH SENSITIVE ELECTRONIC DEVICE WITH CLIPPING FUNCTION AND CLIPPING METHOD

(71) Applicant: CHONG-QING DAI, Shenzhen City (CN)

(72) Inventor: CHONG-QING DAI, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/563,921

(22) Filed: Aug. 1, 2012

(30) Foreign Application Priority Data
Apr. 19, 2012 (CN) 201210116030.X

(51) Int. Cl. G06F 3/041

(52) U.S. Cl. 345/173

(57) ABSTRACT

A touch-sensitive electronic device includes a touch screen receiving and responding to touch operations, and obtaining the location of the touch operations; a display; a memory; and a processing unit, to run a program to activate a clipping module. When the clipping module is activated, the device enters into a clipping mode. In the clipping mode, an image is formed which is the same as the content displayed on the display. The clipping module includes a detection sub-module to detect the touch operations on the formed image in the clipping mode to determine a track of the touch operations. An obtaining sub-module determines a desired area enclosed by the track on the formed image, and obtains the content in the desired area as the object to be clipped; and a storing sub-module stores the object to be clipped in the memory. A clipping method is also provided.

### BACKGROUND

1. Technical Field

The present disclosure relates to touch-sensitive electronic devices with clipping functions and clipping methods, and particularly, to a touch-sensitive electronic device with clipping functions and clipping methods for saving desired segments in the web pages, texts, pictures, or e-books easily.

2. Description of Related Art

Some touch-sensitive electronic devices have the ability to navigate web pages, edit text, read pictures and e-books. Content in the web pages, texts, pictures, and e-books can be operated to move up and down, or switch. However, if a user wants to save desired segments in the web pages, texts, pictures, or e-books, the procedure is quite complicated.

### BRIEF DESCRIPTION OF THE DRAWINGS

Many aspects of the present embodiments can be better understood with reference to the drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a block diagram of a first embodiment of a touch-sensitive electronic device.

FIG. 2 is a first schematic diagram of operating the touch-sensitive electronic device in FIG. 1 by a user.

FIG. 3 is a second schematic diagram of operating the touch-sensitive electronic device in FIG. 1 by the user.

FIG. 4 is a third schematic diagram of operating the touch-sensitive electronic device in FIG. 1 by the user.

FIG. 5 is a block diagram of a second embodiment of a touch-sensitive electronic device.

FIG. 6 is a flowchart of an embodiment of a clipping method implemented by the touch-sensitive electronic device in FIG. 5.

### DETAILED DESCRIPTION

Embodiments of the present disclosure will be described with reference to the accompanying drawings.

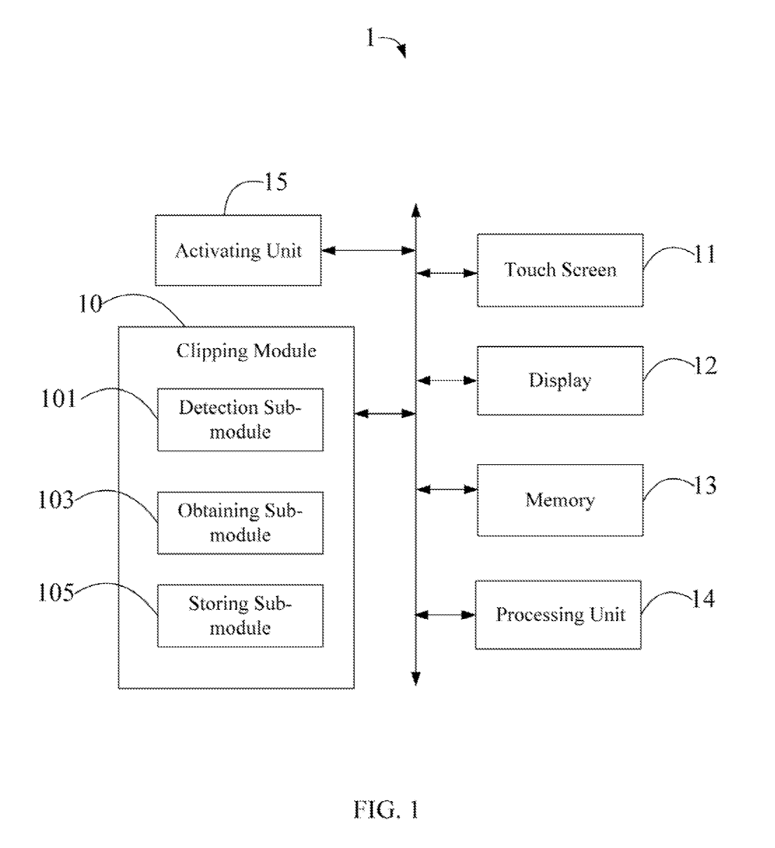

FIG. 1 is a block diagram of a first embodiment of a touch-sensitive electronic device 1. The touch-sensitive electronic device 1 can be a mobile phone, PDA, or portable device with an internet function. The touch-sensitive electronic device 1 includes a clipping module 10, a touch screen 11, a display 12, a memory 13, a processing unit 14, and an activating unit 15. The touch screen 11 is used to receive and respond to touch operations, and obtain locations of the touch operations, such as coordinates of the touch operations. The touch screen 11 can be a capacitive touch screen or resistive touch screen. The display 12 is used to display data including web pages, texts, pictures, and e-books, for example.

The clipping module 10 can be a program to be run on the touch-sensitive electronic device 1 by the processing unit 14. The clipping module 10 may be pre-stored in the memory 13 or embedded in an operating system. The activating unit 15 is used to trigger the processing unit 14 to run the program to activate the clipping module 10.

When the clipping module 10 is activated, the touch-sensitive electronic device 1 enters into a clipping mode. In the clipping mode, an image is obtained which has the same content as the content displayed on the display 12. In one embodiment, a gray background is generated to represent the electronic device 1 which has entered into the clipping mode. The activating unit 15 may be a hardware key or a software button displayed on the display 12. When touching the hardware key or the software button displayed on the display 12, the processing unit 14 is triggered to run the program to activate the clipping module 10.

The clipping module 10 includes a detection sub-module 101, an obtaining sub-module 103, and a storing sub-module 105.

The detection sub-module 101 is used to detect the touch operations on the obtained image in the clipping mode 10 to determine the track of the touch operations. Typically, the detection sub-module 101 detects the coordinates of the touch operations on the touch screen 11, and determines the track based on the coordinates of the touch operation. The track may be determined to be a single line segment, closed curve, discrete points, discrete line segments, or discrete combination of points and line segments. In the embodiment, the track can be displayed on the display 12.

If the track is determined to be a closed curve, the touch operations on the formed image are determined to be finished by determining if two points have the same coordinate values. If so, the touch operations on the formed image are determined to be finished. If not, the touch operations on the formed image are determined not to be finished. If the track is determined to be discrete points or discrete segments, the touch operations on the formed image are determined to be finished by determining whether time intervals between the touch operations are within a predetermined time interval. If so, the touch operations on the formed image are determined not to be finished. If not, the touch operations on the formed image are determined to be finished.

The obtaining sub-module 103 determines a desired area enclosed by the track on the obtained image, and obtains the content in the desired area as an object to be clipped. The obtaining sub-module 103 also obtains the source of the object to be clipped, such as the location of the object to be clipped on the formed image, and the website of the object to be clipped, for example.

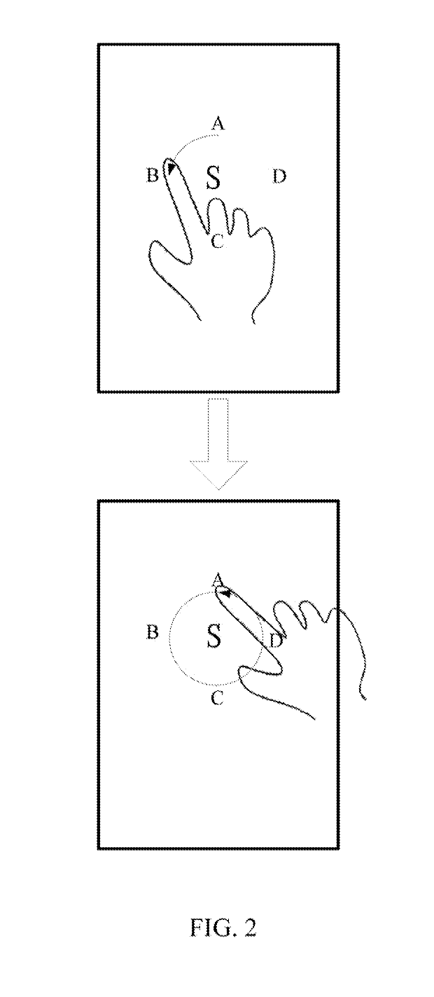

If the track is a closed curve, the obtaining sub-module 103 determines the area enclosed by the closed curve as the desired area, and the content in the track as the object to be clipped. Referring to FIG. 2, the track of the touch operations is the closed curve as A-B-C-D-A, and the enclosed content of “S” is determined as an object to be clipped. The closed curve can be round, oval, polygonal or irregular shaped.

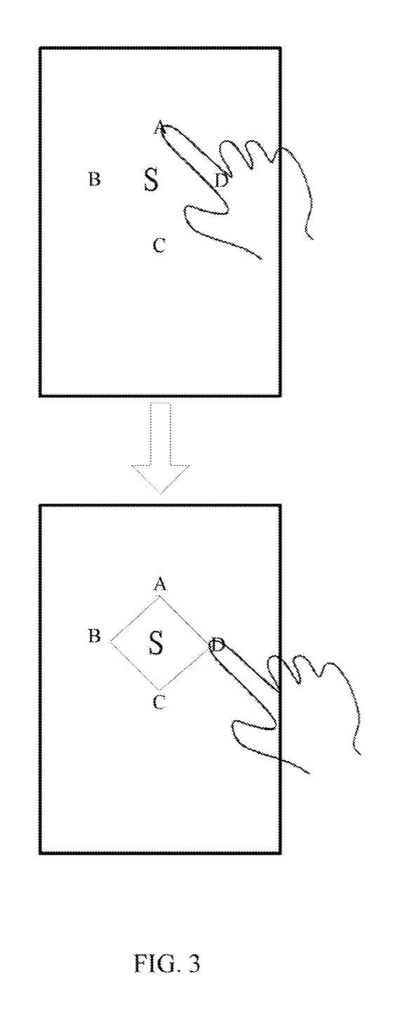

If the track is discrete points, discrete segments, or a combination of discrete points segments, the obtaining sub-module 103 determines a closed graph using a default line (e.g., straight line or arc) to connect the discrete points or discrete segments, and determines the content enclosed by the closed graph as the object to be clipped. Referring to FIG. 3, the track of the touch operations is discrete points A, B, C, D. The obtaining sub-module 103 determines the closed graph A-B-C-D-A using straight lines AB, BC, CD and AD connecting the discrete points A, B, C, D. The enclosed displaying content of “S” is determined as the object to be clipped.

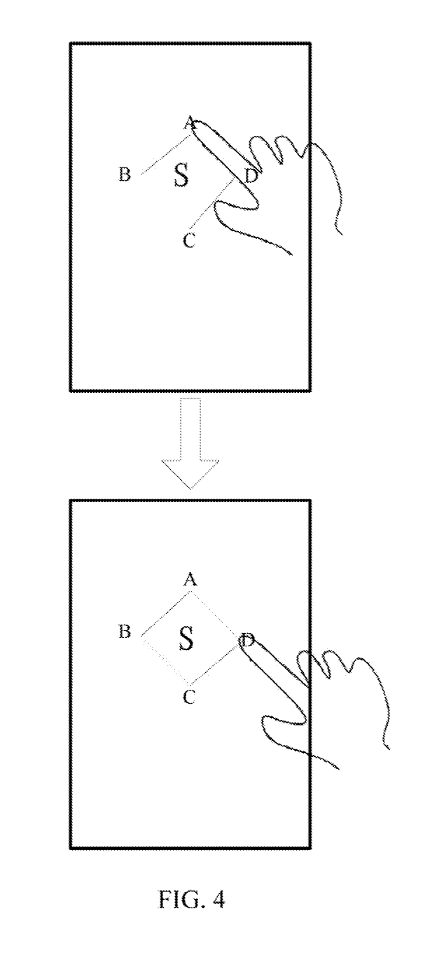

See FIG. 4, the track of the touch operations are discrete lines AB and CD. The obtaining sub-module 103 determines the closed graph A-B-C-D-A using the straight line BC and AD connecting the discrete lines AB and CD. The enclosed displaying content of “S” is determined as the object to be clipped.

If the track is only a single line segment, the obtaining sub-module 103 determines the closed graph using a default graph (e.g., rectangle or circle), for example, the line segment is the diagonal of a rectangle and determines the displaying content enclosed by the rectangle as the object to be clipped.

The storing sub-module 105 is used to store the object to be clipped in the memory 13. Typically, the object to be clipped is stored together with the source of the object to be clipped. The object to be clipped may be stored in a default folder, which is located in a permanent memory or a temporary storage. In another embodiment, an option may be set to indicate to the user for storing the object to be clipped.

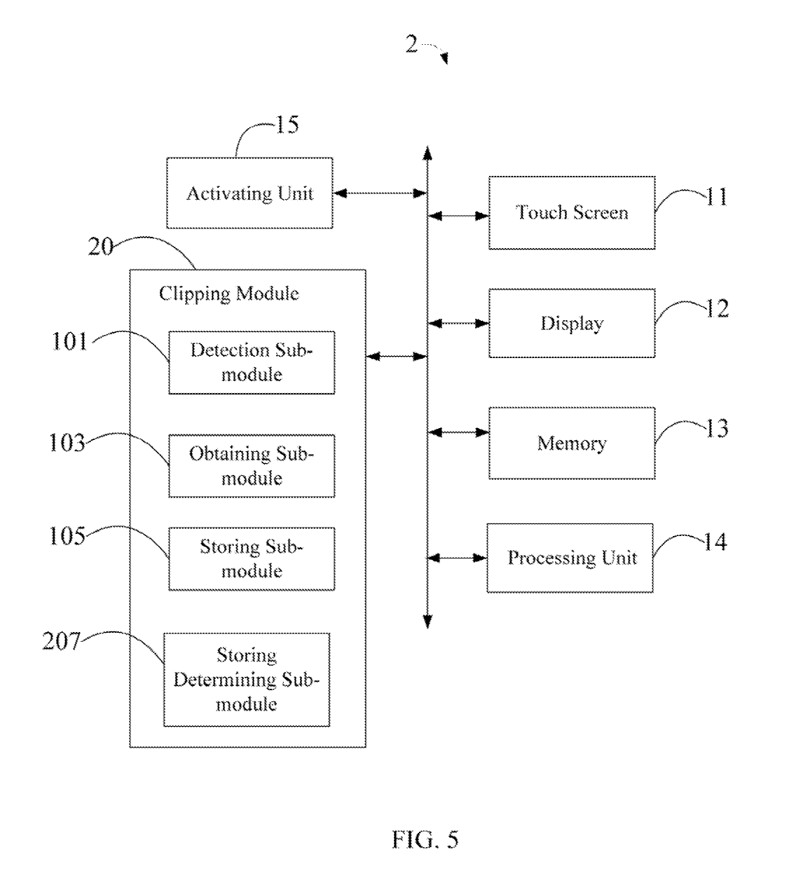

FIG. 5 is a block diagram of a second embodiment of a touch-sensitive electronic device 2. Compared with the touch-sensitive electronic device 1 of FIG. 1, the clipping module 20 further includes a storing determining sub-module 207 for determining whether to store the object to be clipped after the obtaining sub-module 103 determines the desired area enclosed by the track. If the storing determining sub-module 207 determines not to store the object to be clipped after the obtaining sub-module 103 determines the desired area enclosed by the track, the obtaining sub-module 103 will not obtain the content in the desired area as the object to be clipped. If the storing determining sub-module 207 determines to store the object to be clipped after the obtaining sub-module 103 determines the desired area enclosed by the track, the obtaining sub-module 103 will obtain the content in the desired area as the object to be clipped.

The method to determine whether to store the object to be clipped after the obtaining sub-module 103 determines the desired area enclosed by the track can be determined if a click operation is performed on the touch screen 11 after the desired area enclosed by the track is determined. The click operation is identified from the touch operations on the formed image by different pre-determined time intervals. A software or hardware button can be generated to indicate to the user to touch if the user wants to save the object to be clipped.

The activating unit 15 is further used to inactivate the clipping module 10 and thus to be out of the clipping mode by triggering.

In another embodiment, the clipping module 10 already exists in the operating system so it does not need to be activated by the processing unit 14. Thereby the detection sub-module 101 detects the touch operations on the display 12 to determine the track of the touch operations, if the detecting module 101 determines the track of the operations is the closed curve or graph. The touch-sensitive electronic device 1 can enter into the clipping mode automatically because the image is formed which has the same content as the content displayed on the display 12, and the obtaining sub-module 103 and the storing sub-module 105 work automatically, thereby the activating unit 15 is deleted.

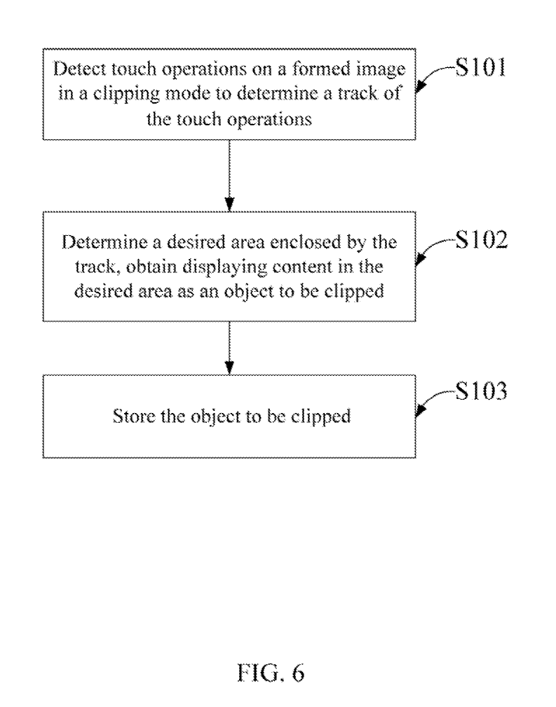

FIG. 6 is a flowchart of an embodiment of a clipping method implemented by the touch-sensitive electronic device 1 in FIG. 1.

In step S101, the detection sub-module 101 detects the touch operations on the formed image in the clipping mode to determine the track of the touch operations.

In step S102, the obtaining sub-module 103 determines the desired area enclosed by the track, obtains the displaying content in the desired area as the object to be clipped. The obtaining sub-module 103 also obtains the source of the object to be clipped.

In step S103, the storing sub-module 105 stores the object to be clipped. Typically, the object to be clipped is stored together with the source of the object to be clipped.

In another embodiment, the method includes another step: the storing determining sub-module 207 determines whether to store the object to be clipped after the obtaining sub-module 103 determines the desired area enclosed by the track. If the storing determining sub-module 207 determines not to store the object to be clipped after the obtaining sub-module 103 determines the desired area enclosed by the track, the obtaining sub-module 103 will not obtain the displaying content in the desired area as the object to be clipped. If the storing determining sub-module 207 determines to store the object to be clipped after the obtaining sub-module 103 determines the desired area enclosed by the track, the obtaining sub-module 103 will obtain the displaying content in the desired area as the object to be clipped. As such, the user can save desired segments in the web pages, texts, pictures, e-books by touching the touch screen 11, which is easy to operate.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A touch-sensitive electronic device with a clipping function, the touch-sensitive electronic device comprising:
a touch screen receiving and responding to touch operations from a user, and obtaining locations of the touch operations;
a display;
a memory; and
a processing unit running a program to activate a clipping module, wherein when the clipping module is activated, the touch-sensitive electronic device enters into a clipping mode; in the clipping mode, an image is formed which has the same content as the content displayed on the display; the clipping module further comprises a detection sub-module detecting the touch operations on the formed image in the clipping mode to determine a track of the touch operations, an obtaining sub-module determining a desired area enclosed by the track on the formed image and obtaining the content in the desired area as the object to be clipped, and a storing sub-module storing the object to be clipped in the memory.

2. The touch-sensitive electronic device of claim 1, further comprising an activating unit triggering the processing unit to run the program to activate the clipping module.

3. The touch-sensitive electronic device of claim 2, wherein the activating unit is a hardware key or a software button displayed on the display; when touching the hardware key or the software button, the processing unit is triggered to run the program to activate the clipping module.

4. The touch-sensitive electronic device of claim 1, wherein upon the condition the track is a closed curve, the touch operations on the formed image are determined to be finished by determining if two points have matching coordinate values; if the two points have matching coordinate values, the touch operations on the formed image are determined to be finished; if the two points do not have matching coordinate values, the touch operations on the formed image are determined not to be finished.

5. The touch-sensitive electronic device of claim 1, wherein upon the condition the track is discrete points or discrete segments, the touch operations on the formed image are determined to be finished by determining whether time intervals between the touch operations are within a predetermined time interval; if the time intervals between the touch operations are within a predetermined time interval, the touch operations on the formed image are determined not to be finished; if the time intervals between the touch operations are not within a predetermined time interval, the touch operations on the formed image are determined to be finished.

6. The touch-sensitive electronic device of claim 1, wherein the obtaining sub-module obtains a source of the object to be clipped, and the storing sub-module is further configured to store the object to be clipped in the memory together with the object to be clipped.

7. The touch-sensitive electronic device of claim 1, wherein upon the condition the track is a closed curve, the obtaining sub-module determines the area enclosed by the closed curve as the desired area, and the displaying content in the track as the object to be clipped.

8. The touch-sensitive electronic device of claim 1, wherein upon the condition the track is discrete points, or discrete segments, or combination of the discrete points and discrete segments, the obtaining sub-module determines a closed graph using default line connecting the discrete points or discrete segments, and determines the displaying content enclosed by the closed graph as the object to be clipped.

9. The touch-sensitive electronic device of claim 1, wherein upon the condition the track is only one line segment, the obtaining sub-module determines the closed graph using a rectangle and determines the displaying content enclosed by the rectangle as the object to be clipped, the line segment being the diagonal of the rectangle.

10. The touch-sensitive electronic device of claim 1, wherein the clipping module further comprises a storing determining sub-module for determining whether to store the object to be clipped after the obtaining sub-module determines the desired area enclosed by the track; if the storing determining sub-module determines not to store the object to be clipped after the obtaining sub-module determines the desired area enclosed by the track, the obtaining sub-module will not obtain the displaying content in the desired area as the object to be clipped; if the storing determining sub-module determines to store the object to be clipped after the obtaining sub-module determines the desired area enclosed by the track, the obtaining sub-module will obtain the displaying content in the desired area as the object to be clipped.

11. A touch-sensitive electronic device with a clipping function, the touch-sensitive electronic device comprising:
a touch screen, receiving and responding to touch operations from a user, and obtaining locations of the touch operations;
a display;
a memory; and
a clipping module further comprising:
a detection sub-module, detecting the touch operations on the formed image in the clipping mode to determine a track of the touch operations,
wherein when the track of the touch operations is a closed curve or graph, the touch-sensitive electronic device enters into a clipping mode, in the clipping mode, an image is formed which has the same content as the content displayed on the display;
an obtaining sub-module, determining a desired area enclosed by the track on the formed image and obtaining the content in the desired area as the object to be clipped; and
a storing sub-module, storing the object to be clipped in the memory.

12. The touch-sensitive electronic device of claim 11, wherein the clipping module further comprises a storing determining sub-module for determining whether to store the object to be clipped after the obtaining sub-module determines the desired area enclosed by the track; if the storing determining sub-module determines not to store the object to be clipped after the obtaining sub-module determines the desired area enclosed by the track, the obtaining sub-module will not obtain the displaying content in the desired area as the object to be clipped; if the storing determining sub-module determines to store the object to be clipped after the obtaining sub-module determines the desired area enclosed by the track, the obtaining sub-module will obtain the displaying content in the desired area as the object to be clipped.

13. A clipping method implemented by a touch-sensitive electronic device with a clipping function, the method comprising:
entering into a clipping mode, in the clipping mode, an image is formed which has the same content as content displayed on a display;
detecting touch operations on the formed image in the clipping mode to determine a track of the touch operations;
determining a desired area enclosed by the track on the formed image, and obtaining content in the desired area as the object to be clipped; and
storing the object to be clipped in a memory.

14. The clipping method of claim 13, wherein upon the condition the track is a closed curve, the touch operations on the formed image are determined to be finished by determining if two points have matching coordinate values; if the two points have matching coordinate values, the touch operations on the formed image are determined to be finished; if the two points do not have matching coordinate values, the touch operations on the formed image are determined not to be finished.

15. The clipping method of claim 13, wherein upon the condition the track is discrete points or discrete segments, the touch operations on the formed image are determined to be finished by determining whether time intervals between the touch operations are within a predetermined time interval; if the time intervals between the touch operations are within a predetermined time interval, the touch operations on the formed image are determined not to be finished; if the time intervals between the touch operations are not within a predetermined time interval, the touch operations on the formed image are determined to be finished.

16. The clipping method of claim 13, wherein the method further comprises the step of obtaining a source of the object to be clipped, and storing the object to be clipped in the memory together with the object to be clipped.

17. The clipping method of claim 13, wherein the step of determining a desired area enclosed by the track on the formed image, and obtaining content in the desired area as the object to be clipped further comprises: upon the condition the track is a closed curve, determining the area enclosed by the closed curve as the desired area, and the displaying content in the track as the object to be clipped.

18. The clipping method of claim 13, wherein the step of determining a desired area enclosed by the track on the formed image, and obtaining content in the desired area as the object to be clipped further comprises: upon the condition the track is discrete points, or discrete segments, or combination of the discrete points and discrete segments, determining a closed graph using default line connecting the discrete points or discrete segments, and determining the displaying content enclosed by the closed graph as the object to be clipped.

19. The clipping method of claim 13, wherein the step of determining a desired area enclosed by the track on the formed image, and obtaining content in the desired area as the object to be clipped further comprises: upon the condition the track is only one line segment, determining the closed graph using a rectangle and determining the displaying content enclosed by the rectangle as the object to be clipped, the line segment being the diagonal of the rectangle.

20. The clipping method of claim 13, wherein the method further comprises the step of determining whether to store the object to be clipped after determining the desired area enclosed by the track, obtaining the displaying content in the desired area as the object to be clipped when determining to store the object to be clipped after determining the desired area enclosed by the track.
